(19) United States
(12) Patent Application Publication
(10) Pub. No.: US 2025/0187654 A1
(43) Pub. Date: Jun. 12, 2025

(54) Method for Operating a Steering System of a Vehicle

(71) Applicant: Robert Bosch GmbH, Stuttgart (DE)

(72) Inventor: Joerg Strecker, Schwaebisch Gmuend (DE)

(21) Appl. No.: 18/845,351

(22) PCT Filed: Jan. 26, 2023
(86) PCT No.: PCT/EP2023/051864

§ 371 Date: Sep. 9, 2024

(30) Foreign Application Priority Data
Mar. 14, 2022 (DE) 10 2022 202 482.6

(51) Int. Cl. B62D 5/04; B62D 5/00

(52) U.S. Cl. CPC B62D 5/0484; B62D 5/006; B62D 5/0487

(57) ABSTRACT

A method for operating a steering system of a vehicle, which has a steer-by-wire steering system with (i) an operating unit having a steering handle and a feedback actuator that interacts with the steering handle, and (ii) at least one wheel steering angle control element, which is operatively connected to the operating unit, for changing a steering angle of at least one wheel, includes: monitoring an operation of the feedback actuator using a monitoring function; in an operating state in which disturbance and/or failure of the feedback actuator is ascertained, modifying a steering characteristic of the steering system; monitoring a driver target specification for the wheel steering angle control element using an additional monitoring function; and, when a dynamic of the driver target specification exceeds a threshold value in the operating state, ascertaining a compensation variable, which is used to modify the driver target specification to modify the steering characteristic.

### PRIOR ART

The invention is based upon a method for operating a steering system of a vehicle according to the preamble of claim 1. In addition, the invention relates to a computing unit for performing such a method, a steering system with such a computing unit and a vehicle with such a steering system.

Vehicles with conventional steering systems are known from the prior art, in which a steering handle, for example in the form of a steering wheel, is mechanically connected to a wheel steering angle control element in the form of a steering gear via a steering column. Also known are vehicles comprising steer-by-wire steering systems which do not require a direct mechanical connection between a steering handle and the steered vehicle wheels and in which a driver target specification and/or steering specification is only transmitted electrically. A steer-by-wire steering system of this type usually comprises an operating unit with a steering handle and a feedback actuator as well as at least one wheel steering angle control element that is mechanically separate from the operating unit and can, e.g., be designed as a central regulator or as a single-wheel controller.

Furthermore, such steer-by-wire steering systems are always designed redundantly for reasons of operational safety. With regard to the operating unit, one option is to design the operating unit to be fail-safe or fail-operational. In addition, the operating unit can also be designed to be fail-operational with regard to detecting a driver target specification and fail-safe with regard to a feedback torque provided by the feedback actuator. With a corresponding design of the operating unit, a malfunction and/or failure of the feedback actuator due to the sudden loss of the feedback torque can lead to unintentional steering movements at the steering handle, which are interpreted by the steering system as a driver target specification and/or steering specification and can consequently lead to an undesired reaction of the vehicle. Possible methods for handling such errors can, e.g., be found in DE 10 2016 009 684 A1 and DE 10 2018 222 442 A1.

Therefore, the object of the invention is in particular to provide a method having improved properties with regard to a mode of operation. This object is achieved by the features of claims 1, 12, 13, and 14, while advantageous embodiments and further developments of the invention can be gathered from the dependent claims.

### DISCLOSURE OF THE INVENTION

The invention relates to a method for operating a steering system of a vehicle, in particular a motor vehicle. The steering system is designed as a steer-by-wire steering system and comprises an operating unit, which comprises at least one steering handle and at least one feedback actuator that interacts with the steering handle, and at least one wheel steering angle control element, which is operatively connected to the operating unit, for changing a steering angle of at least one vehicle wheel, whereby an operation of the feedback actuator is monitored using a monitoring function, and in at least one operating state in which a disturbance and/or a failure of the feedback actuator is ascertained using the monitoring function, a steering characteristic of the steering system is modified.

The invention also proposes that a driver target specification for the wheel steering angle control element, in particular applied by a driver to the steering handle, is monitored using an additional monitoring function and, in the event that a dynamic of the driver target specification exceeds a threshold value in the operating state, a compensation variable, in particular in the form of an offset, is ascertained, wherein the driver target specification is modified using the compensation variable in order to modify the steering characteristic. The operating state in which a disturbance and/or a failure of the feedback actuator is ascertained using the monitoring function therefore corresponds in particular to a fault operating state. Furthermore, the steering characteristic is in particular changed by modifying the driver target specification using the compensation variable such that, in the operating state and in particular in the case of a transition of the feedback actuator from an active and/or fully operable state to a passive and/or degraded state, a substantially consistent steering behavior is provided and/or achieved and an unintended steering movement of a driver due to a disturbance and/or failure of the feedback actuator does not result in an undesirable vehicle response. In particular, this design can improve functionality, whereby the controllability and/or manageability of the vehicle can be advantageously improved in the event of a fault or if the active feedback torque of the feedback actuator is omitted. In addition, an advantageously adaptive and/or variable method can be provided in which the steering characteristic can be flexibly adapted to current operating conditions. In addition, advantageous maneuverability of the vehicle can be achieved and operational safety increased.

In the present case, the steering system is designed as a steer-by-wire steering system, in which the driver target specification and/or steering specification is advantageously transmitted to the vehicle wheels purely electrically. For this purpose, the steer-by-wire steering system comprises the, in particular redundantly designed, operating unit and at least one wheel steering angle control element that is mechanically separate from the operating unit and, in particular, redundantly designed. Preferably, the operating unit and the wheel steering angle control element are designed to be at least partially fail-operational. The term “wheel steering angle control element” is to be understood as an actuator unit coupled to at least one vehicle wheel, which is intended to transmit a driver target specification and/or steering specification, in particular of a driver, to the vehicle wheel by changing a wheel steering angle of at least one vehicle wheel and thereby advantageously control at least one alignment of the vehicle wheel and/or influence a direction of travel of the vehicle. To this end, the wheel steering angle control element advantageously comprises at least one steering regulator element, for example in the form of a gear rack, and at least one steering actuator, for example in the form of an electric motor, which is operatively connected to the steering regulator element. The wheel steering angle control element can be designed as a central regulator and be assigned to at least two vehicle wheels, in particular steerable and preferably designed as front wheels. Alternatively, however, the wheel steering angle control element can also be designed as a single-wheel controller and assigned to exactly one vehicle wheel, in particular a steerable wheel, preferably designed as a front wheel. Furthermore, the term “feedback actuator” is understood to mean an actuator unit, in particular different from the wheel steering angle control element and in particular directly mechanically connected to the steering handle, which is intended to detect signals, forces and/or torques from the steering handle, in particular directly, and/or to transmit them to the steering handle, in particular directly. In the present case, the feedback actuator is provided in a normal operating state at least to provide an active feedback torque and thereby to generate a steering resistance and/or a restoring torque on the steering handle. Furthermore, the feedback actuator is intended in this context to adjust a steering feel that can be perceived in particular via the steering handle. For this purpose, the feedback actuator can comprise at least one further electric motor. In particular, the expression “a disturbance and/or failure of the feedback actuator” is understood to mean a disturbance and/or failure of the feedback actuator itself and/or of a peripheral module that interacts with the feedback actuator, such as a power supply, and a disturbance of the feedback actuator caused thereby. Furthermore, the wheel steering angle is basically equivalent to other variables between the steering actuator and the vehicle wheel, such as a deflection of the steering regulator element and/or a deflection position of the wheel steering angle control element and/or a motor movement. The same applies to a deflection of the steering handle, which is equivalent to other variables between the steering handle and the feedback actuator, such as a steering column angle and/or a motor angle. For the torque values on the vehicle wheel and on the steering handle, the same equivalence of variables applies between the vehicle wheel/steering handle and the respective connected actuator.

Furthermore, the vehicle and preferably the steering system comprise at least one computing unit, which is intended to perform the method for operating the steering system. The term “computing unit” is understood to mean an electrical and/or electronic unit having an information input, information processing, and an information output. Advantageously, the computing unit also has at least one processor, at least one operating memory, at least one input means and/or output means, at least one operating program, at least one control routine and/or regulation routine, at least one calculation routine, at least one determination routine, at least one evaluation routine and/or at least one adaptation routine. In particular, the computing unit in the present case comprises at least one monitoring function for monitoring an operation of the feedback actuator. In addition, the computing unit comprises at least one additional monitoring function for monitoring a driver target specification applied to the steering handle, in particular by a driver, and in particular for monitoring the dynamics of the driver target specification. The computing unit is intended in particular to monitor and evaluate an operation of the feedback actuator using the monitoring function. Furthermore, the computing unit is intended, in particular, to monitor and evaluate a driver target specification for the wheel steering angle control element, in particular applied to the steering handle by a driver, using the additional monitoring function. In addition, the computing unit is intended to change a steering characteristic of the steering system in at least one operating state in which a malfunction and/or a failure of the feedback actuator is ascertained and a dynamic of the driver target specification exceeds a threshold value, and to modify the driver target specification using a compensation variable for this purpose. In this context, the computing unit can be provided in particular to use an error signal provided by the monitoring function and/or a detection signal provided by the additional monitoring function to adjust the steering characteristic. Preferably, the computing unit is in this case preferably integrated into a control device of the vehicle, e.g., a central vehicle control device, or preferably a control device of the steering system, in particular in the form of a steering control device. The term “provided” is understood in particular as meaning specifically programmed, designed and/or equipped. In particular, the phrase “an object being provided for a specific function” is intended to mean that the object fulfills and/or performs this specific function in at least one application state and/or operating state.

It is further proposed that a current driving situation and/or an imminent driving situation is considered when changing the steering characteristic and, in particular, when modifying the driver target specification using the compensation variable, which in particular allows the steering characteristic to be changed to adapt to the situation. In this case, the steering characteristic is in particular changed as a function of the current driving situation and/or the imminent driving situation. The current driving situation and/or the imminent driving situation can, e.g., be ascertained and/or forecasted based on at least one vehicle variable, for example, a yaw rate, a deflection of the steering handle, and/or a steering movement. Alternatively or additionally, however, the current driving situation and/or the imminent driving situation can also be derived from a route planning of a navigation system of the vehicle and/or a corresponding sensor system, for example in the form of a camera system, of the vehicle.

The operating state corresponds advantageously to cornering. Preferably, the steering characteristic is only changed if the wheel steering angle of the vehicle wheel is not equal to zero and is advantageously at least 0.1°, in particular in terms of magnitude. It is particularly preferable for the steering characteristic to be changed when the vehicle is cornering, while no change in the steering characteristic is made when the vehicle is traveling in a straight line. This can in particular increase an operational reliability in critical driving situations. In addition, a particularly efficient procedure can be advantageously provided.

In addition, it is proposed that a dynamic and/or an absolute value of the driver target specification, for example, a maximum deflection of the steering handle and/or a steering speed of the steering handle, is considered when changing the steering characteristic and, in particular, when modifying the driver target specification using the compensation variable. The dynamics and/or the absolute value of the driver target specification are preferably determined using the additional monitoring function. In particular, an overreaction of the driver when the active feedback torque of the feedback actuator is removed can be ascertained and the steering characteristic can be adjusted as a function thereof.

Furthermore, it is proposed that in order to change the steering characteristic, the driver target specification is modified using the compensation variable such that the driver target specification is reduced in the operating state. In particular, a driver target specification modified, in particular using the compensation variable, which is forwarded to the wheel steering angle control element in the operating state, in particular instead of the driver target specification, and/or by means of which the wheel steering angle control element is actuated in the operating state, is therefore reduced compared to the driver target specification, preferably by at least 10%, more preferably by at least 20% and particularly preferably by at least 30%. The modified driver target specification is advantageously reduced by a maximum of 90%. This reduces the vehicle response and the situation becomes more manageable for the driver.

It is further proposed that the driver target specification and the compensation variable are added together to change the steering characteristic. In particular, the addition is used to determine a modified driver target specification, in particular using the compensation variable. This makes it particularly easy to modify the driver target specification using software.

According to a further embodiment, it is proposed that a maximum level of the compensation variable is limited, in particular such that a possible actual need for a stronger steering of the vehicle is made possible and an intentional over-steering of the changed steering characteristic is possible. This is an advantageous way of ensuring that intentional steering movements, for example, during an evasive maneuver, can still be carried out.

It is also preferably proposed that the compensation variable is determined using a compensation function to which at least the driver target specification and/or the detection signal provided by the additional monitoring function and the error signal provided by the monitoring function are supplied as input variables. In this case, the computing unit can in particular include the compensation function. In addition, further vehicle variables can be supplied to the compensation function, such as a vehicle speed, a yaw rate and/or a lateral acceleration. In addition, when determining the compensation variable using the compensation function, a dynamic gradient limitation is preferably used, by means of which an increase in the driver target specification is limited as a function of at least one driving parameter, wherein the compensation variable is advantageously determined on the basis of a difference between a gradient-limited driver target specification and the driver target specification. In this context, the driving parameter defines in particular conditions under which a corresponding gradient limitation takes place. In addition, a state machine can be used to determine a maximum gradient of the dynamic gradient limitation. A reduction of the driver target specification is preferably unlimited. This embodiment can be used to advantageously change the steering characteristic.

A particularly high level of operational reliability can be achieved in particular if the dynamic gradient limitation is dependent on a current driving situation and/or a current driving situation is taken into account when limiting the gradient. In this context, it is preferable to at least take into account whether the vehicle is cornering or not. In addition, a vehicle speed can advantageously be taken into account.

In addition, it is proposed that a steering direction and/or steering movement correlated with the driver target specification is taken into account as a driving parameter and/or, in the event that the operating state corresponds to cornering, a cornering direction is taken into account. In this context, for example, a distinction can be made between a left and a right turn and/or constant cornering and cornering with active steering movements. In the case of constant cornering, for example, only a minimum gradient is used for dynamic gradient limitation, while in the case of active steering movements by the driver, the gradient can be additionally increased. It is particularly advantageous to activate the dynamic gradient limitation in this context only when cornering and when the driver does not steer back to a central position or zero position. In this way, a gradient limitation adapted to the situation can be achieved.

According to a preferred embodiment, it is further proposed that the change in the steering characteristic in the operating state is initially maintained for a first time interval and then reduced in a controlled manner over a defined second time interval, in particular in the form of a defined time duration. In particular, the first time interval can be a defined period of time or correspond to a predefined driving situation, for example, until the next straight line or until the next corner change. In particular, this can improve the transition from a steering characteristic in an error-free normal operating state to a steering characteristic in an error operating state.

In a further embodiment, it is also proposed that a vehicle speed is considered when changing the steering characteristic and, in particular, when modifying the driver target specification using the compensation variable. In particular, the vehicle speed is at least taken into account when determining the dynamic gradient limitation. The steering characteristic can thereby be particularly flexibly adjusted to current operating conditions.

The method for operating the steering system is not intended to be limited to the application and embodiment described hereinabove. In particular, the method for operating the steering system in order to achieve the functioning described herein can comprise a number of individual elements, components, and units that differs from the number specified herein.

### DRAWINGS

Further advantages follow from the description of the drawings hereinafter. The drawings show an exemplary embodiment of the invention.

Shown are:

FIGS. 1a-b a vehicle with a steering system designed as a steer-by-wire steering system in a simplified representation,

FIG. 2 exemplary diagrams of various signals for operating the steering system, and

FIG. 3 an exemplary flow chart comprising the main method steps of a method for operating the steering system.

### DESCRIPTION OF THE EXEMPLARY EMBODIMENT

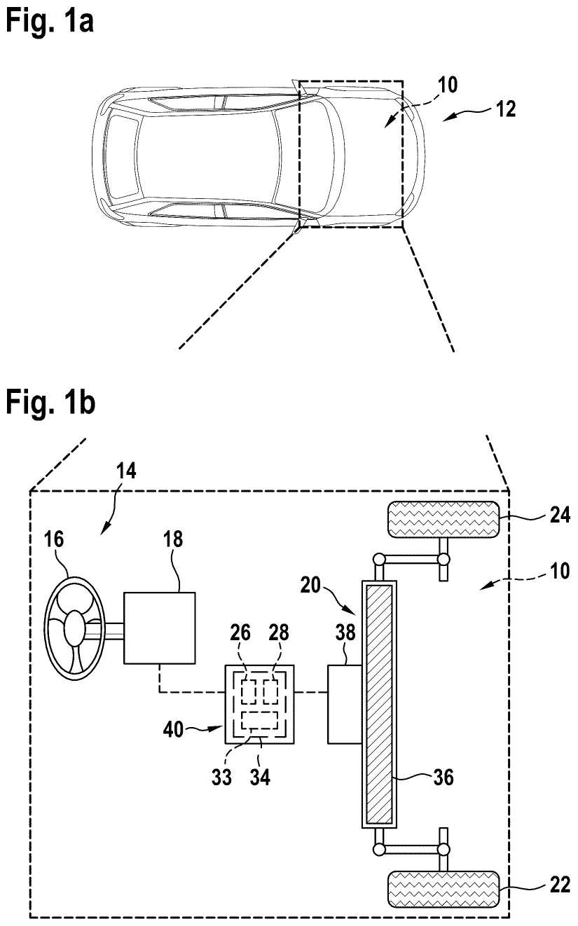

FIGS. 1a and 1b show a simplified illustration of a vehicle 12 which is, e.g., designed as a passenger vehicle comprising a plurality of vehicle wheels 22, 24 and a steering system 10. The steering system 10 is operatively connected to the vehicle wheels 22, 24, and is provided to influence a direction of travel of the vehicle 12. Furthermore, the steering system 10 is designed as a steer-by-wire steering system in the present case, in which a driver target specification 30 or steering specification is transmitted electrically to the vehicle wheels 22, 24 in at least one operating state.

The steering system 10 comprises an operating unit 14, in particular actuatable by a driver and/or an occupant. The operating unit 14 comprises a steering handle 16, for example, in the form of a steering wheel, and a feedback actuator 18 which is in particular mechanically coupled to the steering handle 16. In the present case, the feedback actuator 18 is provided in a normal operating state at least to provide an active feedback torque and thereby to generate a steering resistance and/or a restoring torque on the steering handle 16. To this end, the feedback actuator 18 comprises at least one electric motor (not shown) designed in particular as a permanently excited synchronous motor. Furthermore, the operating unit 14 is designed to be fail-operational with regard to detecting the driver target specification 30, in particular via the steering handle 16, and fail-safe with regard to a feedback torque provided by the feedback actuator 18. A steering handle could alternatively also be designed as a joystick, a steering lever, and/or as a steering ball or the like. A feedback actuator could further comprise a plurality of electric motors. In addition, an operating unit could in principle also be fail-safe or fail-operational.

The steering system 10 further comprises a known wheel steering angle control element 20. The wheel steering angle control element 20 is mechanically separate from the operating unit 14. The wheel steering angle control element 20 is purely electrically connected to the operating unit 14. Further, the wheel steering angle control element 20 is, e.g., designed as a central regulator. The wheel steering angle control element 20 is operatively connected to at least two of the vehicle wheels 22, 24, in particular two front wheels, and is intended to convert the driver target specification 30 into a steering movement of the vehicle wheels 22, 24. For this purpose, the wheel steering angle control element 20 comprises a steering regulator element 36 designed (by way of example) as a gear rack, and a steering actuator 38 that interacts with the steering regulator element 36. In the present case, the steering actuator 38 comprises at least one further electric motor (not shown), designed in particular as a permanently excited synchronous motor, and is provided for controlling the steerable vehicle wheels 22, 24. A steering system could in principle basically also comprise a plurality of wheel steering angle control elements, in particular designed as single-wheel controllers. Furthermore, a steering actuator could comprise a plurality of electric motors.

The vehicle 12 further comprises a control device 40. In the present case, the control device 40 is designed as a steering control device and is therefore part of the steering system 10. The control device 40 comprises an electrical connection to the wheel steering angle control element 20. The control device 40 also comprises an electrical connection to the operating unit 14. The control device 40 is provided at least for controlling an operation of the steering system 10. In the present case, the control device 40 is intended to control the steering actuator 38 as a function of a signal from the operating unit 14 as, e.g., a function of the driver target specification 30. The control device 40 can further be provided to actuate the feedback actuator 18 depending on a signal from the wheel steering angle control element 20.

The control device 40 comprises a computing unit 34 for this purpose. The computing unit 34 comprises at least one processor (not depicted), e.g., in the form of a microprocessor, and at least one operating memory (not depicted). The computing unit 34 also comprises at least one operating program stored in the operating memory and has at least one calculation routine, at least one determination routine, at least one evaluation routine, and at least one adaptation routine. In addition, the computing unit 34 in the present case comprises at least one monitoring function 26, at least one additional monitoring function 28 and at least one compensation function 33. A control device could in principle also be different from a steering control device and designed, e.g., as a single, central vehicle control device having a central computing unit. It is also conceivable to provide separate control devices and/or computing units for one wheel steering angle control element as well as one operating unit and communicatively interconnect them.

The vehicle 12 and/or the steering system 10 can also comprise further components and/or assemblies (not shown), such as an internal vehicle sensor system known per se for detecting at least one vehicle variable, for example a yaw rate, an external sensor system known per se, for example in the form of a camera system, and/or an inherently known navigation system.

In the event of a malfunction and/or failure of the feedback actuator 18, under certain circumstances and/or in certain driving situations, such as when cornering, the sudden loss of the feedback torque when the feedback actuator 18 transitions from an active and/or functional state to a passive and/or degraded state can lead to unintended steering movements at the steering handle 16, which are interpreted by the steering system 10 as a driver target specification and/or steering specification and can consequently lead to an undesired vehicle reaction. In this context, it is assumed that the passive behavior of the feedback actuator 18 with regard to torque feedback is sufficient to operate the vehicle 12 safely, and only the transition from the active to the passive case can present difficulties with regard to controllability. This difficulty is caused by the feedback torque decreasing abruptly in the event of a corresponding malfunction and/or failure of the feedback actuator 18 because the inherent passive friction in the steering system 10 is significantly lower than the feedback torque in the normal operating state. Particularly when cornering, a sudden reduction in the feedback torque, and consequently a counter-torque on the steering handle 16, can lead to safety-critical situations because the driver can only readjust their holding force after a delay due to their reaction time, so the driver steers further into the bend than intended.

To avoid such safety-critical situations, a method for operating the steering system 10 is therefore proposed hereinafter. In the present case, the computing unit 34 is provided to perform the method and comprises for this purpose a computer program having corresponding program code means. Alternatively, however, a computing unit of a control device, associated with an operating unit, could also be intended for performing the method.

According to the invention, operation of the feedback actuator 18 is monitored using the monitoring function 26 and a driver target specification 30 for the wheel steering angle control element 20 is monitored using the additional monitoring function 28. In addition, in at least one operating state in which a malfunction and/or a failure of the feedback actuator 18 is determined using the monitoring function 26 and a dynamic of the driver target specification 30 determined using the additional monitoring function 28 exceeds a threshold value, a compensation variable 31 for changing a steering characteristic of the steering system 10 is determined. The steering characteristic of the steering system 10 is then changed by modifying the driver target specification 30 using the compensation variable 31, which in this case corresponds in particular to an offset. In the present case, the steering characteristic is changed by modifying the driver target specification 30 by using the compensation variable 31 such that in the operating state, and in particular in the case of a transition of the feedback actuator 18 from an active and/or fully operable state to a passive and/or degraded state, a substantially consistent steering behavior is provided and/or achieved and an unintended steering movement of a driver due to a disturbance and/or failure of the feedback actuator 18 does not result in an undesirable vehicle response. The change in steering characteristic is then initially maintained for a first time interval, for example until the next straight line or until the next corner change, and then reduced in a controlled manner over a defined second time interval or a defined period of time. In this context, controlled degradation can be carried out in a similar way to the process described in DE 10 2021 213 389 A1, for example.

According to the present method, a current driving situation and/or an imminent driving situation is also taken into account and the steering characteristic is changed as a function of the current driving situation and/or the imminent driving situation. Preferably, a corresponding change in the steering characteristic takes place only when the vehicle 12 is cornering or when imminent cornering is detected. As a result, the operating state corresponds to cornering, whereby the steering characteristic is only changed when the wheel steering angle of the vehicle wheels 22, 24 is not equal to zero.

Furthermore, a dynamic and/or an absolute value of the driver target specification 30 for the wheel steering angle control element 20, e.g., a maximum deflection of the steering handle 16 and/or a steering speed of the steering handle 16, is considered when changing the steering characteristic and, in particular, when modifying the driver target specification 30 using the compensation variable 31.

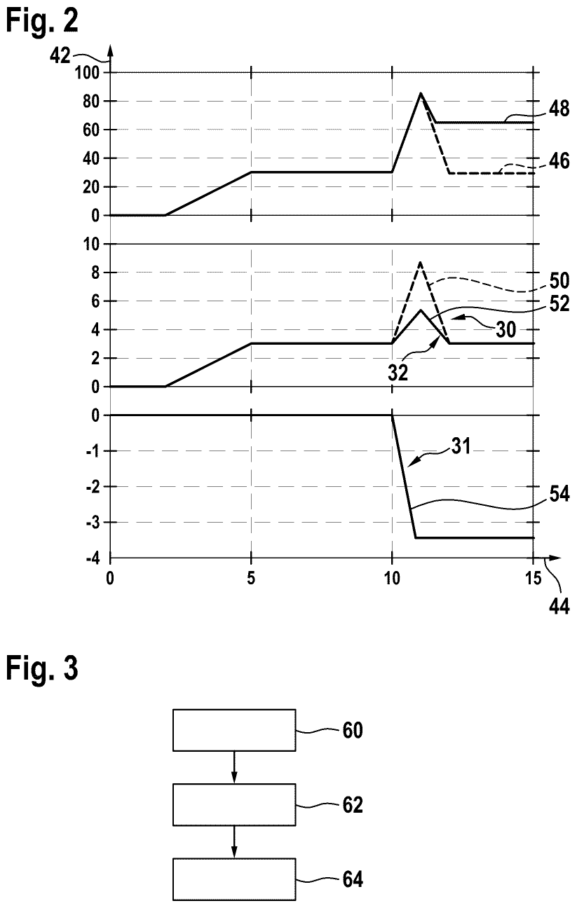

In addition, the driver target specification 30 is modified using the compensation variable 31 such that a modified driver target specification 32, which is forwarded to the wheel steering angle control element 20 in the operating state instead of the driver target specification 30 and/or by means of which the wheel steering angle control element 20 is actuated in the operating state, is reduced, in particular in comparison to the driver target specification 30 (see in particular also FIG. 2). Decreasing the driver target specification 30 is particularly useful if it is ascertained on the basis of the current driving situation and/or the imminent driving situation and/or the dynamics and/or absolute value of the driver target specification 30 that the driver is steering further into the bend than intended. Decreasing the driver target specification 30 in this case reduces the vehicle response and the situation becomes more manageable for the driver. In principle, controllability is increased by decreasing the driver target specification 30, as the removal of driver steering precision due to the lack of feedback torque can be at least partially compensated for by a reduction in vehicle response.

Specifically, the driver target specification 30 and the compensation variable 31 are added together in the present case to determine the modified driver target specification 32 for the wheel steering angle control element 20. The following applies in this context:

$$a n g R {W}_{m o d} = a n g R {W}_{d r i v e r} + a n g R {W}_{c o m p}$$

Here, angRW_{mod} describes the modified driver target specification 32, angRW_{driver} the driver target specification 30 and angRW_{comp} the compensation variable 31.

In the present case, the compensation function 33 is also used to determine the compensation variable 31. The driver target specification 30 and an error signal provided by the monitoring function 26 are fed to this as input variables. Preferably, an absolute value is first formed in this context by multiplying the driver target specification 30 by its sign, so that only an excessively rapid increase in the driver target specification 30 in one direction, in particular in a positive direction, is relevant for determining the compensation variable 31. In addition, a dynamic gradient limitation is used, by means of which an increase in the driver target specification 30 can be limited and a gradient-limited driver target specification can be determined as required, depending on at least one driving parameter. In this context, the driving parameter defines in particular conditions under which a corresponding gradient limitation takes place. In addition, a state machine can be used to determine a maximum gradient of the dynamic gradient limitation. By default, the gradient is selected such that the modified driver target specification 32 in the operating state is reduced compared to the driver target specification 30. However, there is no limit to the reduction of the driver target specification 30. By forming a difference between the gradient-limited driver target specification and the driver target specification 30, an offset is then created, which is then multiplied by the sign of the driver target specification 30 to determine the compensation variable 31 in order to ensure that the driver target specification 30 is always reduced in the operating state. In addition, a maximum height of the compensation variable 31 can still be limited to allow for a possible actual need for greater steering of the vehicle 12.

The dynamic gradient limitation is also dependent on the current driving situation. In this context, it is at least taken into account whether the vehicle is cornering or not. A vehicle speed can also be taken into account. In addition, a steering direction, steering movement and/or cornering direction correlated with the driver target specification 30 is taken into account as a driving parameter. In this context, a distinction is made, for example, between a left-hand bend and a right-hand bend as well as constant cornering and cornering with active steering movements. If cornering is constant, for example, only a minimal gradient is used, whereas if the driver is actively steering, the gradient can be additionally increased, in particular using an amplification factor, in order to ensure the desired steering. The amplification factor can be selected depending on the vehicle speed, for example, wherein the increase becomes smaller as the vehicle speed increases. In addition, the gradient limitation is only activated in this case when cornering and if the driver does not steer back to a center position or zero position. For example, a further threshold value for the steering speed can be defined for this purpose, which can be used to achieve reliable detection of the driver steering back to the center position or zero position. A steering movement to the center position or zero position can in principle also be defined as an exit condition of the compensation function 33, wherein the vehicle speed should also be below a limit value.

FIG. 2 shows exemplary diagrams of various signals for operating the steering system 10.

An ordinate axis 42 is in the form of a value axis. A time is shown in [s] on an abscissa axis 44. Curve 46 shows a hypothetical course of a deflection of the steering handle 16, in particular in the form of an actual steering wheel angle, without changing the steering characteristic by modifying the driver target specification 30. Curve 48 shows a course of a deflection of the steering handle 16, in particular in the form of an actual steering wheel angle with a change in the steering characteristic by modifying the driver target specification 30. A curve 50 shows a progression of the driver target specification 30 or a wheel steering angle of the vehicle wheels 22, 24 without changing the steering characteristic by modifying the driver target specification 30. A curve 52 shows a progression of the modified driver target specification 32 or a wheel steering angle of the vehicle wheels 22, 24 with a change in the steering characteristic by modifying the driver target specification 30. A curve 54 also shows a progression of the compensation variable 31.

FIG. 2 shows that the driver first turns into a bend and then travels at a constant radius until the feedback actuator 18 fails at second 10. Curves 50 and 52 clearly show the reduced wheel steering angle of the vehicle wheels 22, 24 achieved by the method according to the invention and the associated lower vehicle response. In addition, it can be seen from curves 46 and 48 that the modification of the driver target specification 30 using the compensation variable 31 can result in a skewed position of the steering handle 16, which, however, disappears again promptly due to the controlled reduction of the change in the steering characteristic.

Finally, FIG. 3 shows an exemplary flow chart with the main method steps of the process for operating the steering system 10.

Method step 60 corresponds to a normal operating state, in particular an error-free state. In this case, the driver target specification 30 is forwarded to the wheel steering angle control element 20 so that the wheel steering angle control element 20 is actuated using the driver target specification 30. In addition, operation of the feedback actuator 18 is monitored using the monitoring function 26 and the driver target specification 30 for the wheel steering angle control element 20 is monitored using the additional monitoring function 28.

In method step 62, a disturbance and/or failure of the feedback actuator 18 is ascertained using the monitoring function 26. In addition, the additional monitoring function 28 is used to determine that a dynamic of the driver target specification 30 exceeds a threshold value.

In a subsequent method step 64, a compensation variable 31 is determined and a steering characteristic of the steering system 10 is changed by modifying the driver target specification 30 using the compensation variable 31 and determining a modified driver target specification 32. The modified driver target specification 32 is then forwarded to the wheel steering angle control element 20, in particular instead of the driver target specification 30, so that the wheel steering angle control element 20 is actuated using the modified driver target specification 32.

The exemplary flow chart in FIG. 3 is only intended to describe an exemplary method for operating the steering system 10. In particular, individual method steps can also vary, or additional method steps can be added. In this context, it is conceivable, for example, to take a current driving situation into account. In addition, the compensation variable 31 can be determined using a compensation function 33, to which the driver target specification 30 and an error signal provided by the monitoring function 26 are supplied as input variables, wherein a dynamic gradient limitation is used when determining the compensation variable 31, by means of which an increase in the driver target specification 30 is limited as a function of at least one driving parameter.

1. A method for operating a steering system of a vehicle in which the steering system is designed as a steer-by-wire steering system and comprises (i) an operating unit with at least one steering handle and at least one feedback actuator that interacts with the steering handle, and (ii) at least one wheel steering angle control element, which is operatively connected to the operating unit, for changing a steering angle of at least one vehicle wheel, the method comprising:
monitoring an operation of the feedback actuator using a monitoring function;
in at least one operating state in which a disturbance and/or a failure of the feedback actuator is ascertained via the monitoring function, modifying a steering characteristic of the steering system
monitoring a driver target specification for the wheel steering angle control element using an additional monitoring function;
in the event that a dynamic of the driver target specification exceeds a threshold value in the operating state, ascertaining a compensation variable; and
modifying the driver target specification using the compensation variable in order to modify the steering characteristic.

2. The method according to claim 1, wherein the modifying of the steering characteristic includes considering a current driving situation and/or an imminent driving situation.

3. The method according to claim 1, wherein the at least one operating state corresponds to cornering and the modifying of the steering characteristic includes changing the steering characteristic only when the wheel steering angle of the vehicle wheel is not equal to zero.

4. The method according to claim 1, wherein the modifying of the steering characteristic includes considering a dynamic and/or an absolute value of the driver target specification.

5. The method according to claim 1, wherein the modifying of the steering characteristic includes modifying the driver target specification using the compensation variable such that the driver target specification is reduced in the at least one operating state.

6. The method according to claim 1, wherein the driver target specification and the compensation variable are added together in order to change the steering characteristic.

7. The method according to claim 1, wherein a maximum height of the compensation variable is limited.

8. The method according to claim 1, wherein the ascertaining of the compensation variable comprises:
using a compensation function, to which the driver target specification and an error signal provided by the monitoring function are supplied as input variables; and
using a dynamic gradient limitation that limits an increase in the driver target specification as a function of at least one driving parameter.

9. The method according to claim 8, wherein the dynamic gradient limitation takes is dependent on a current driving situation.

10. The method according to claim 8, wherein:
the at least on driving parameter includes (i) a steering direction and/or steering movement correlated with the driver target and/or (ii) in the event that the operating state corresponds to cornering, a cornering direction.

11. The method according to claim 1, wherein the change in the steering characteristic in the operating state is initially maintained for a first time interval and is then reduced in a controlled manner over a defined second time interval.

12. A computing unit comprising:
at least one operating memory; and
at least one processor configured to execute program instructions stored in the at least one operating memory to perform the method according to claim 1.

13. A steering system comprising:
an operating unit which comprises at least one steering handle and at least one feedback actuator that interacts with the steering handle;
at least one wheel steering angle control element operatively connected to the operating unit and configured to control a steering angle of at least one vehicle wheel; and
the computing unit according to claim 12.

14. A vehicle comprising:
the steering system according to claim 13.

15. The method according to claim 1, wherein the vehicle is a motor vehicle.

16. The method according to claim 1, wherein the compensation variable is an offset.

17. The steering system according to claim 13, wherein the steering system is a steer-by-wire steering system.

18. The vehicle according to claim 14, wherein the vehicle is a motor vehicle.
